(19) United States
(12) Patent Application Publication
(10) Pub. No.: US 2026/0264093 A1
(43) Pub. Date: Sep. 10, 2026

(54) BLOOD SEPARATION DEVICE

(71) Applicant: Tsung-Ju WU, Pusin Township (TW)

(72) Inventor: Tsung-Ju WU, Pusin Township (TW)

(21) Appl. No.: 19/557,624

(22) Filed: Mar. 5, 2026

(30) Foreign Application Priority Data
Mar. 6, 2025 (TW) 114108389

(51) Int. Cl. B04B 5/04

(52) U.S. Cl. CPC B04B 5/0407

(57) ABSTRACT

A blood separation device includes a container, a separation member and a transportation tube. The container has an accommodation space and an opening. The separation member is movably disposed in the accommodation space and is in fluid-tight contact with the container to divide the accommodation space into an operation chamber and a storage chamber. The operation chamber is adjacent to the opening. The storage chamber is isolated from the operation chamber, and is away from the opening. The separation member has a channel. One end of the transportation tube is disposed in the operation chamber and is connected to the separation member, and another end of the transportation tube extends out of the opening. The channel extends to spatially communicate with the transportation tube and the storage chamber.

### CROSS-REFERENCE TO RELATED APPLICATION

This application claims priority to Taiwanese Invention Patent Application No. 114108389, filed on Mar. 6, 2025, the entire disclosure of which is incorporated by reference herein.

### FIELD

The disclosure relates to a container for centrifugation, and more particularly to a blood separation device used for extracting platelet-rich plasma (PRP).

### BACKGROUND

Human blood is composed of plasma and blood cells including red blood cells, white blood cells, and platelets. When the blood is centrifuged at a certain rate, the blood cells and plasma are stratified according to different relative densities. Specifically, the red blood cells have relatively high density, so they settle at the bottom; the plasma has relatively low density, so it is located at the top; the white blood cells and platelets have density between those of the red blood cells and plasma, so they are located at the middle, and are usually called “buffy coat.” Since platelets can be used in regenerative medicine and other high-value medical applications, there are a variety of existing extraction methods which are widely used, such as colloid centrifugation, single centrifugation, double centrifugation, etc. Compared to the colloid centrifugation and single centrifugation, the double centrifugation provides greater platelet concentration. When the double centrifugation is used to extract platelet-rich plasma (PRP), blood is centrifuged twice. In practice, blood is first put into a blood separation container, and is roughly stratified into an upper plasma layer, a buffy coat layer, and a lower red blood cell layer after centrifugation. Then, the upper plasma layer and the buffy coat layer are drawn from the top of the blood separation container with a syringe and then are injected into another blood separation container. Next, after the drawn content in the another blood separation container is centrifuged again, it is stratified and the buffy coat layer settles at the bottom, and then the upper plasma layer is drawn from the top of the another blood separation container with another syringe. Finally, the buffy coat layer is drawn out with yet another syringe and PRP is obtained. Through the abovementioned double centrifugation, several times of transportation are required, which is not only time-consuming and labor-intensive, but also has the concern of contamination.

Referring to FIG. 1, Taiwanese Utility Model Patent No. M598150 discloses a conventional centrifuge container 1. The centrifuge container 1 includes a main body 11 defining an internal space 111, a connecting pipe 12 connected to the bottom of the main body 11 and spatially communicating with the internal space 111, a cover body 13 disposed on the main body 11 to close the internal space 111, and a sealing cap 14 disposed on a distal end of the connecting pipe 12 away from the main body 11 to close the connecting pipe 12. The centrifuge container 1 is first filled with blood and then the first centrifugation is performed, so that the blood in the centrifuge container 1 is stratified into a plasma layer (A), a red blood cell layer (B), and a buffy coat layer (C). Then, the sealing cap 14 is removed to draw the red blood cell layer (B) out of the centrifuge container 1. Subsequently, the second centrifugation is performed, and then the buffy coat layer (C) is drawn out of the centrifuge container 1 to obtain PRP.

However, during discharge of the red blood cell layer (B), the layers (A), (B), (C) may be mixed due to eddy diffusion, so that the red blood cell layer (B) may not be separately discharged. That is, white blood cells and platelets (i.e., a part of the buffy coat layer (C)) may be discharged along with the red blood cell layer (B) due to eddy diffusion, which adversely affects the platelet concentration. Additionally, after the red blood cell layer (B) is discharged, a portion of red blood cells may still be left on an inner wall of the main body 11; thus, when the buffy coat layer (C) comes into contact with the aforementioned region (i.e., the inner wall of the main body 11 where the portion of red blood cells are left) during the second centrifugation, the red blood cells may be contained in the buffy coat layer (C), resulting in an increase in discomfort after PRP injection. Thus, there is still room for improvement.

### SUMMARY

Therefore, an object of the disclosure is to provide a blood separation device that can alleviate at least one of the drawbacks of the prior art.

According to the disclosure, the blood separation device includes a container, a separation member and a transportation tube. The container has an accommodation space and an opening. The separation member is movably disposed in the accommodation space and is in fluid-tight contact with the container to divide the accommodation space into an operation chamber and a storage chamber. The operation chamber is adjacent to the opening. The storage chamber is isolated from the operation chamber, and is away from the opening. The separation member has a channel. One end of the transportation tube is disposed in the operation chamber and is connected to the separation member, and another end of the transportation tube extends out of the opening. The channel extends to spatially communicate with the transportation tube and the storage chamber.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly sectional view of a conventional centrifuge container.

FIG. 2 is a partly sectional view of an embodiment of a blood separation device according to the disclosure.

FIGS. 3A and 3B are schematic partly-sectional views illustrating a process for introducing blood into the embodiment.

FIGS. 4A and 4B are fragmentary schematic partly-sectional views illustrating a process for discharging a red blood cell layer from the embodiment after first centrifugation.

FIGS. 5A, 5B and 5C are schematic partly-sectional views illustrating a process for extracting platelets from the embodiment after second centrifugation.

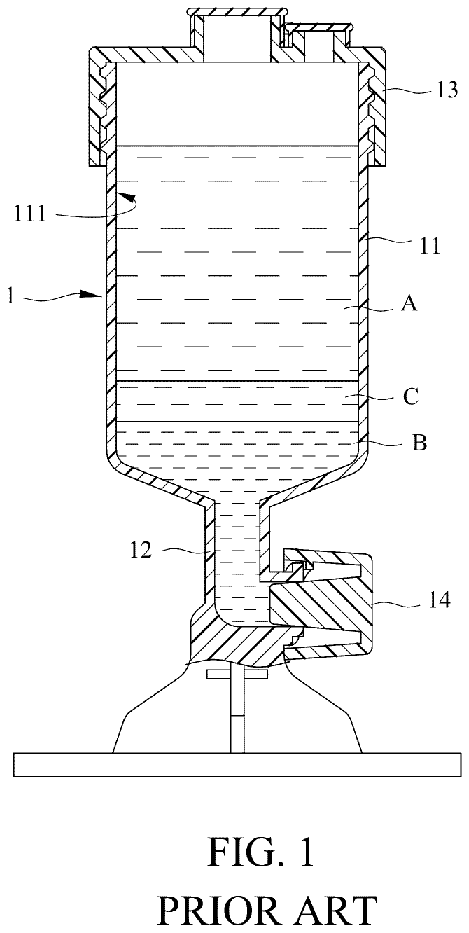

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

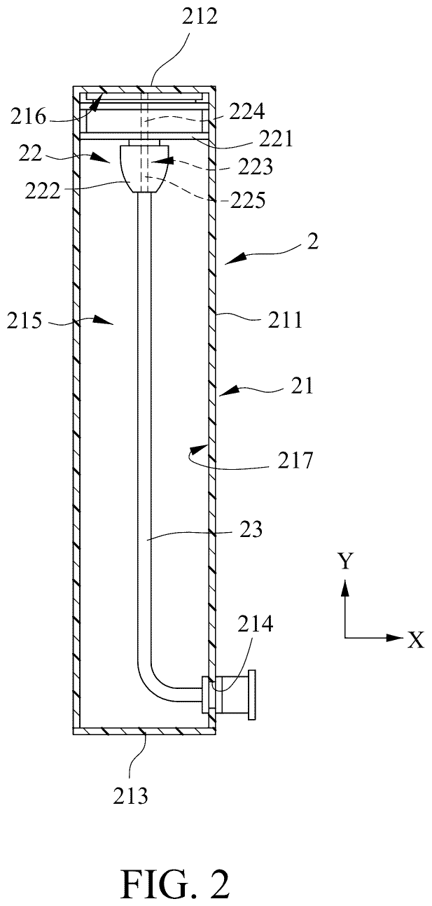

Referring to FIG. 2, an embodiment of a blood separation device 2 according to the disclosure includes a container 21 that defines an accommodation space 215, a separation member 22 that is movably disposed in the accommodation space 215, and a transportation tube 23 that is disposed in the accommodation space 215 and that is connected to the separation member 22. The container 21 includes a surrounding wall 211 that is substantially tubular, and that surrounds the separation member 22, a first end wall 212 that is connected to one end of the surrounding wall 211, and a second end wall 213 that is connected to another end of the surrounding wall 211. Specifically, the surrounding wall 211, the first end wall 212 and the second end wall 213 cooperatively define the accommodation space 215. The container 21 has an opening 214 that is formed in and extends through the surrounding wall 211 in a first direction (X). The opening 214 is away from the first end wall 212 and is adjacent to the second end wall 213. The surrounding wall 211 may be marked with graduations (not shown) in a second direction (Y) transverse to the first direction (X), but is not limited thereto.

The separation member 22 creates a seal with the container 21. The separation member 22 includes a piston 221 which is surrounded by the surrounding wall 211 of the container 21, and a connector 222 which is connected to the piston 221. Specifically, an outer surface of the piston 221 of the separation member 22 is in fluid-tight contact with an inner surface of the surrounding wall 211 of the container 21, so that the accommodation space 215 is divided into an operation chamber 217 and a storage chamber 216 by the separation member 22. In some embodiments, a sealing ring (not shown) that is made of rubber or silicone is sleeved on the outer surface of the piston 221, in other embodiments, the piston 221 itself is made of rubber or silicone, but is not limited to such. The operation chamber 217 is adjacent to the opening 214. The storage chamber 216 is isolated from the operation chamber 217 and the opening 214, and is away from the opening 214. The piston 221, the surrounding wall 211 and the first end wall 212 cooperatively define the storage chamber 216, and the piston 221, the surrounding wall 211 and the second end wall 213 cooperatively define the operation chamber 217. The connector 222 is located in the operation chamber 217.

The separation member 22 has a channel 223 that extends to spatially communicate with the transportation tube 23 and the storage chamber 216. The channel 223 of the separation member 22 has a through hole 224 that extends through the piston 221 and that spatially communicates with the storage chamber 216, and an extension hole 225 that extends through the connector 222, and that spatially communicates with the through hole 224 and the transportation tube 23. One end of the transportation tube 23 is disposed in the operation chamber 217 and is connected to the connector 222 of the separation member 22, and another end of the transportation tube 23 extends out of the opening 214, isolates the operation chamber 217 from the opening 214, and is closed by a cover (not shown).

The piston 221 abuts against the first end wall 212 before blood is introduced into the storage chamber 216, so a volume of the storage chamber 216 is nearly 0. At this time, the transportation tube 23 is closed, so the accommodation space 215 is in a closed state, and the accommodation space 215 and the components disposed therein will not be contaminated by air from the external environment.

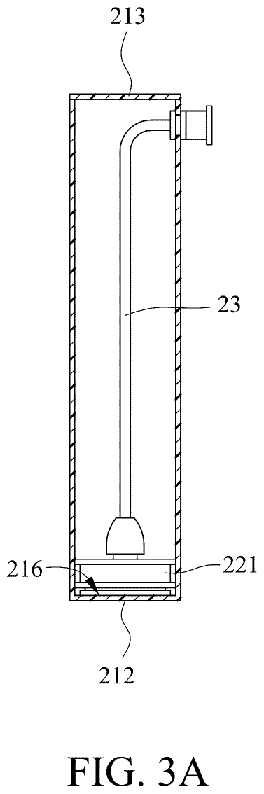

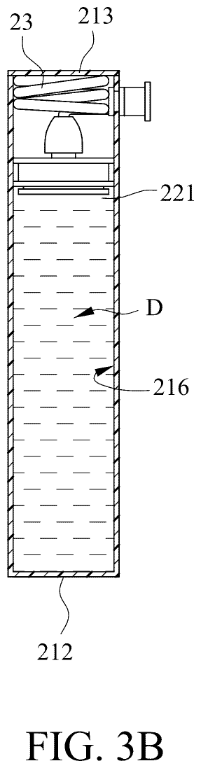

Referring to FIGS. 2, 3A and 3B, a method for extracting platelet-rich plasma (PRP) using the embodiment of the disclosure is as follows. The embodiment is disposed to let the first end wall 212 be located at the bottom and the second end wall 213 be located at the top. Blood (D) is introduced into the storage chamber 216 through the transportation tube 23 by a syringe (not shown). As the input of the blood (D) increases, the piston 221 is continuously pushed upwards and is gradually close to the second end wall 213, and the volume of the storage chamber 216 gradually increases while a volume of the operation chamber 217 gradually decreases. After the introduction of the blood (D) is completed, the syringe is removed from the embodiment and the transportation tube 3 is closed, and the embodiment is inverted for first centrifugation (the container 21 is turned such that the first end wall 212 is located at the top and the second end wall 213 is located at the bottom).

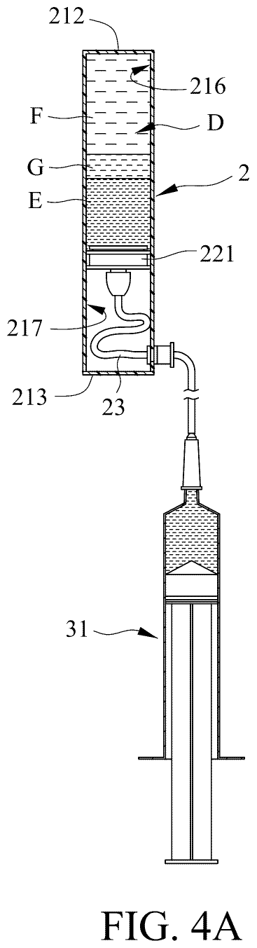

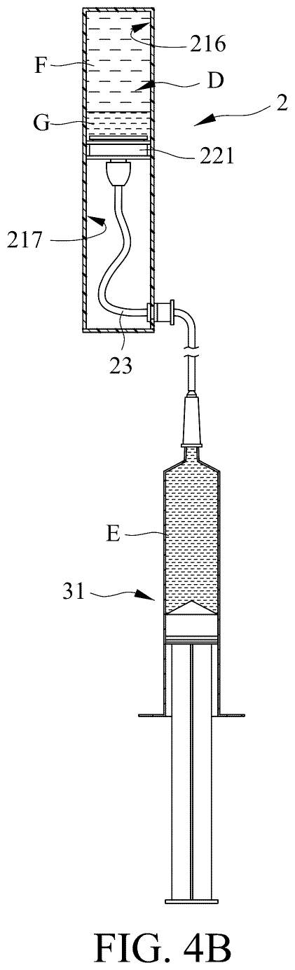

Referring to FIGS. 2, 4A, and 4B, after the first centrifugation, the blood (D) is stratified into a red blood cell layer (E) settling at the bottom, a plasma layer (F) located at the top, and a buffy coat layer (G) located between the red blood cell layer (E) and the plasma layer (F). A collector 31 is connected to the transportation tube 23 to generate a negative pressure and thereby draw the blood (D) (specifically, the red blood cell layer (E)) thereinto. At this stage, the piston 221 is moved upwards to approach the first end wall 212 by pressure, and hence the volume of the storage chamber 216 gradually decreases while the volume of the operation chamber 217 gradually increases. After the red blood cell layer (E) is completely discharged, the collector 31 is removed from the transportation tube 23 and the transportation tube 23 is closed again. The plasma layer (F) and the buffy coat layer (G) still stay in the storage chamber 216. During discharge of the red blood cell layer (E), different from the prior art, owing to Pascal's law, white blood cells and platelets (i.e., a part of the buffy coat layer (G)) may not be discharged along with the red blood cell layer (E), so that the platelet concentration may not be adversely affected.

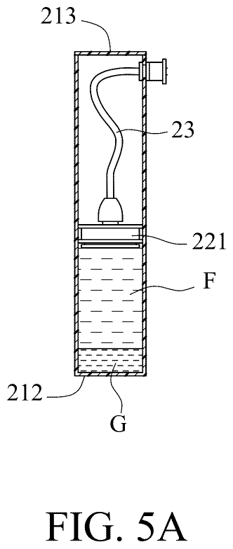

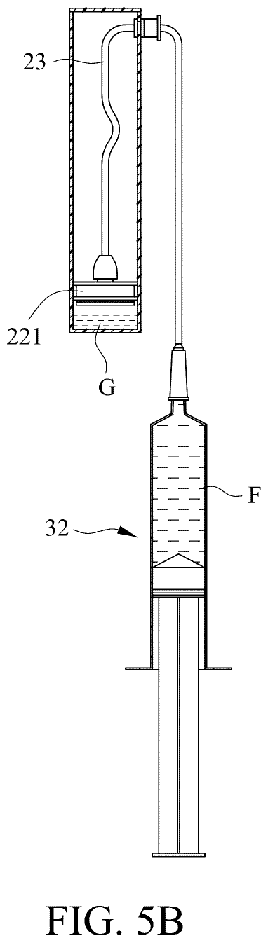

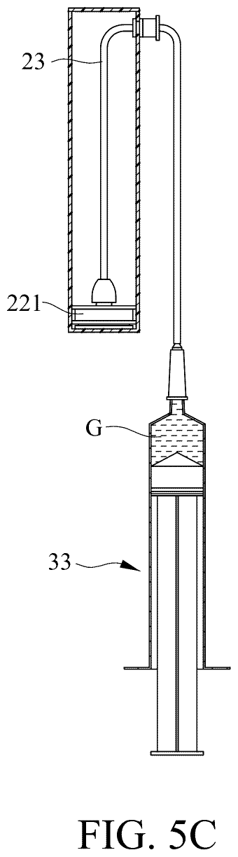

Referring to FIGS. 2, 5A, 5B and 5C, the embodiment is inverted again for the second centrifugation (the container 21 is turned such that the first end wall 212 is located at the bottom and the second end wall 213 is located at the top). After the second centrifugation, the buffy coat layer (G) settles at the bottom. Another collector 32 is connected to the transportation tube 23 to generate a negative pressure and thereby draw the plasma layer (F) thereinto, and after discharge of the plasma layer (F), yet another collector 33 is connected to the transportation tube 23 to generate a negative pressure and thereby draw the buffy coat layer (G) thereinto. Hence, during the double centrifugation, the blood (D) does not have to be transported to different containers several times, and the accommodation space 215 and the blood (D) disposed therein will not be contaminated by air from the external environment.

During discharge of the red blood cell layer (E), by virtue of Pascal's law, the piston 221 is moved upwards, and the volume of the storage chamber 216 decreases; hence, a portion of the surrounding wall 211 that contacts the red blood cell layer (E) before the discharge is no longer located in the storage chamber 216. Such design not only prevents the plasma layer (F) and the buffy coat layer (G) from contacting the red blood cells left in the accommodation space 215 during the second centrifugation, but also prevents eddy diffusion during the discharge of the red blood cell layer (E), so that the red blood cell layer (E) may be clearly and separately discharged and not contaminate the plasma layer (F) and the buffy coat layer (G), thereby enhancing platelet concentration and reducing excessive left red blood cells.

According to the results of experiments, platelet concentration may be improved by using the embodiment during double centrifugation, and contamination of the red blood cells may be reduced, resulting in a decrease in discomfort after PRP injection.

To sum up, by using the embodiment to extract PRP, the blood (D) does not have to be transported to different containers, which prevents the blood (D) from being contaminated during the transportation, thereby increasing safety. Moreover, the embodiment prevents eddy diffusion during the discharge of the red blood cell layer (E), so that the red blood cell layer (E) may be clearly and separately discharged (i.e., platelets may not be discharged together), and after the discharge of the red blood cell layer (E), a portion of the surrounding wall 211 that contacts the red blood cell layer (E) before the discharge is no longer located in the storage chamber 216, so that platelets do not contact the left red blood cells, which ensures the platelet concentration. Thus, the object of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A blood separation device, comprising:
a container that has an accommodation space, and an opening;
a separation member that is movably disposed in said accommodation space and that is in fluid-tight contact with said container to divide said accommodation space into an operation chamber and a storage chamber, said operation chamber being adjacent to said opening, said storage chamber being isolated from said operation chamber, and being away from said opening, said separation member having a channel; and
a transportation tube, one end of which is disposed in said operation chamber and is connected to said separation member, and another end of which extends out of said opening;
wherein said channel extends to spatially communicate with said transportation tube and said storage chamber.

2. The blood separation device as claimed in claim 1, wherein said container includes a surrounding wall that surrounds said separation member, and that is in fluid-tight contact with said separation member, a first end wall that is connected to one end of said surrounding wall and that is away from said opening, and a second end wall that is connected to another end of said surrounding wall and that is adjacent to said said opening.

3. The blood separation device as claimed in claim 2, wherein:
said separation member includes a piston which is surrounded by said surrounding wall of said container, and an outer surface of which is in fluid-tight contact with said surrounding wall, and a connector which is connected to said piston; and
said piston, said surrounding wall and said first end wall cooperatively define said storage chamber, and said piston, said surrounding wall and said second end wall cooperatively define said operation chamber.

4. The blood separation device as claimed in claim 3, wherein said channel of said separation member has a through hole that extends through said piston and that spatially communicates with said storage chamber, and an extension hole that extends through said connector, and that spatially communicates with said through hole and said transportation tube.
